(19) United States
(12) Patent Application Publication
(10) Pub. No.: US 2009/0271517 A1
(43) Pub. Date: Oct. 29, 2009

(54) METHOD AND APPARATUS FOR WIRELESS DEVICE RECONNECTION HANDLING

(75) Inventors: Joe G. Naylor, Newton, MA (US); George Emilov, Montrose, CA (US); Nikolay Borisov Bankov, Montrose, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: WEBMESSENGER, INC., Tujunga, CA (US)

(21) Appl. No.: 12/110,254

(22) Filed: Apr. 25, 2008

(51) Int. Cl. G06F 15/16

(52) U.S. Cl. 709/227

(57) ABSTRACT

An apparatus and method for wireless device reconnection handling are disclosed involving a keep-alive request being sent from a wireless device to a server based on a first keep-alive time interval. At least one indicator that the keep-alive request has failed is received. A second keep-alive time interval different from the first keep-alive time interval is defined in response to at least one condition being satisfied and in response to the receiving. The defining includes defining the second keep-alive time interval when a response to the keep-alive request is not received from the server within a threshold time period associated with the at least one condition. In addition, the server is associated with a first wireless network. The first keep-alive time interval is defined before the sending based on a preference associated with a server associated with a second wireless network different than the first wireless network.

### BACKGROUND

The present disclosure relates to wireless device reconnection handling. In particular, it relates to methods and apparatus for wireless device reconnection handling.

### SUMMARY

The present disclosure relates to an apparatus and method for wireless devices reconnection handling involving a keep-alive request being sent from a wireless device to a server based on a first keep-alive time interval. At least one indicator that the keep-alive request has failed is received. A second keep-alive time interval different from the first keep-alive time interval is defined in response to at least one condition being satisfied and in response to the receiving.

In one or more embodiments, the defining includes defining the second keep-alive time interval when a response to the keep-alive request is not received from the server within a threshold time period associated with the at least one condition. In addition, the server is associated with a first wireless network. The first keep-alive time interval is defined before the sending based on a preference associated with a server associated with a second wireless network different than the first wireless network. In one or more embodiments, the keep-alive request is a first keep-alive request, and the at least one indicator is an indicator that a first communication link has been terminated by the server.

In one or more embodiments, a second communication link is established between the wireless device and the server based on at least one reconnection algorithm. In addition, a second keep-alive request is sent to the server based on the second keep-alive time interval.

In one or more embodiments, the keep-alive request is a first keep-alive request, and the sending including sending the first keep-alive request over a first communication link. An operating system of the wireless device is queried after the receiving to determine whether the wireless device is in an in-coverage state. A second communication link is established between the wireless device and the server in response to the wireless device being in the in-coverage state. A second keep-alive request is sent to the server based on the second keep-alive time interval.

In one or more embodiments, a processor-readable medium storing code is employed, representing instructions to cause a processor to perform a process. The code comprises code to query an operating system of a wireless device to determine whether the wireless device is in an in-coverage state in response to a timing signal produced by a keep-alive timer, where the timing signal is configured to trigger a keep-alive request; code to receive at least one indicator that the wireless device is in the in-coverage state in response to the query; and code to send a request to establish a communication link between the wireless device and a server in response to the at least one indicator.

In one or more embodiments, the code further comprises code to produce a keep-alive request in response to the timing signal and in response to the at least one indicator that the wireless device is in the in-coverage state. The communication link is a first communication link. The code to query includes code to query in response to at least one indicator that a second communication link between the wireless device and the server has been terminated.

In one or more embodiments, the code to query includes code to query after at least one in-coverage indicator produced by the operating system of the wireless device has failed to trigger a reconnection attempt. The timing signal is produced based on a dynamically modified keep-alive time interval. In one or more embodiments, the code to query includes code to query when the wireless device is in a disconnected state.

In one or more embodiments, at least one indicator is received at the wireless device that a first communication link between a wireless device and a server has been established. The first communication link is based on a first communication protocol. At least one indicator that a second communication link between the wireless device and the server has been terminated is received. The second communication link is based on a second communication protocol. The wireless device is prevented from re-establishing the second communication link in response to the at least one indicator that the second communication link has been terminated.

In one or more embodiments, the at least one indicator that the second communication link has been terminated is based on a status of a server socket associated with the second communication link. The preventing includes preventing until the first communication link has been terminated. The first communication link is a voice communication link, and the second communication link is a data communication link. The wireless device is prevented from sending a keep-alive request associated with the second communication link to the server in response to the at least one indicator that the second communication link has been terminated.

In one or more embodiments, a notification that the second communication link has been terminated is sent to a user-interface of the wireless device. The preventing includes preventing execution of at least one reconnection algorithm. The server is associated with a network that supports simultaneous voice communication links and data communication links.

In one or more embodiments, a coverage detection module is configured to receive at least one indicator that a wireless device is in an in-coverage state from an operating system of the wireless device during a first portion of a keep-alive time cycle without querying the operating system. The coverage detection module configured to query the operating system to determine whether the wireless device is in the in-coverage state during a second portion of the keep-alive time cycle. The first portion is different than the second portion. A reconnect module is configured to establish at least a portion of a communication link between the wireless device and a server when the wireless device is in the in-coverage state.

In one or more embodiments, the coverage detection module is configured to actively query the operating system when the wireless device is in a disconnected state. A keep-alive module is configured to send a keep-alive request to the server when the wireless device is in the in-coverage state and in a connected state. The wireless device is in the connected state when the communication link between the wireless device and the server has been established.

### DRAWINGS

These and other features, aspects, and advantages of the present disclosure will become better understood with regard to the following description, appended claims, and accompanying drawings where:

FIG. 1 is a schematic block diagram that illustrates a remote device that has a connection management module, according to at least one embodiment of the present disclosure.

FIG. 2 is a schematic diagram that illustrates a connection management module that has a keep-alive module, a connection module, a coverage detection module, and a control module, according to at least one embodiment of the present disclosure.

FIG. 3 is a schematic diagram that illustrates a connection management procedure that can be implemented by a connection management module of a remote device, according to at least one embodiment of the present disclosure.

FIG. 4 is a timing diagram that illustrates a signal exchange scenario based on the connection management procedure illustrated in FIG. 3, according to at least one embodiment of the present disclosure.

FIG. 5A is a graph that illustrates a keep-alive timing signal from a keep-alive timer, according to at least one embodiment of the present disclosure.

FIG. 5B is a graph that illustrates a connection request indicator, according to at least one embodiment of the present disclosure.

FIG. 5C is a graph that illustrates a connection failure indicator, according to at least one embodiment of the present disclosure.

FIG. 5D is a graph that illustrates a mode of a coverage detection module based on the keep-alive timing signal shown in FIG. 5A, the connection request indicator shown in FIG. 5B, and the connection failure indicator shown in FIG. 5C, according to at least one embodiment of the present disclosure.

FIG. 6 is a flowchart that illustrates a method for dynamically modifying a keep-alive time interval at a remote device, according to at least one embodiment of the present disclosure.

FIG. 7 is a flowchart that illustrates a method for managing a connection of a data communication link when a voice communication link associated with a remote device is active, according to at least one embodiment of the present disclosure.

### DETAILED DESCRIPTION

The apparatus and methods disclosed herein provide an operative system for reconnection handling. Specifically, this system employs methods and apparatus for wireless device reconnection handling.

Known wireless communication device applications, such as for example wireless voice applications, are configured to automatically attempt to reconnect with an entity within a network when a connection with the entity is prematurely terminated. For example, if a connection with a network entity is terminated when the wireless communication device moves into an out-of-coverage area where the network cannot be contacted, relatively large amounts of battery power can be consumed by the wireless communication device as it attempts to reconnect while in the out-of-coverage area. Even after the wireless communication device is moved back into an in-coverage area where the wireless communication device can communicate with the network entity, reconnecting with the network entity can be delayed by, for example, communication failures within the wireless communication device. Thus, a need exists for methods and apparatus related to reconnection handling associated with a wireless communication device.

In the following description, numerous details are set forth in order to provide a more thorough description of the system. It will be apparent, however, to one skilled in the art, that the disclosed system may be practiced without these specific details. In the other instances, well known features have not been described in detail so as not to unnecessarily obscure the system.

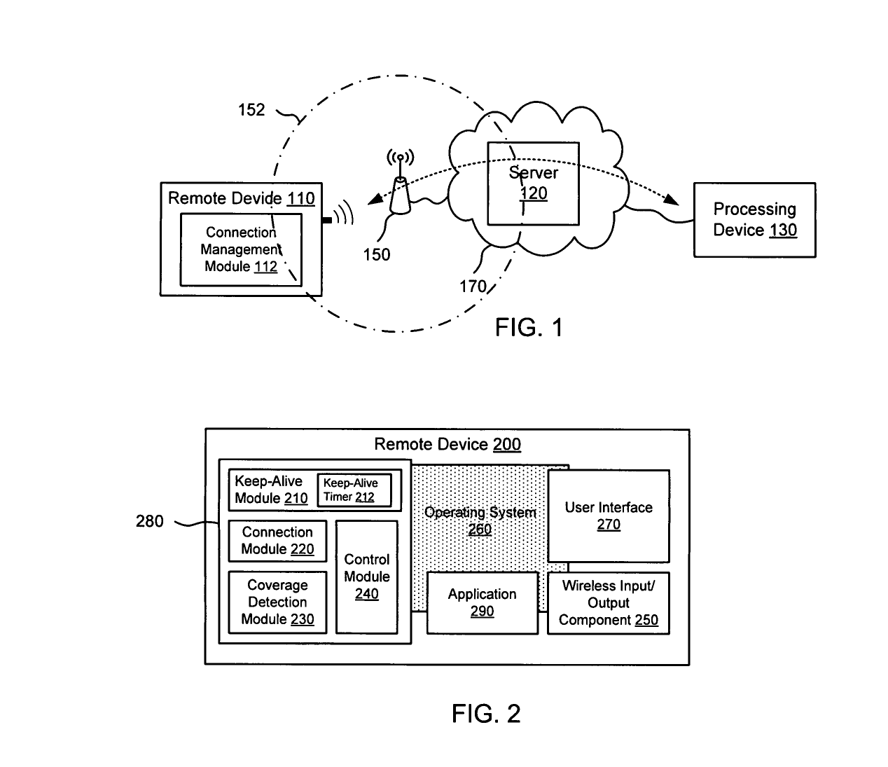

FIG. 1 is a schematic block diagram that illustrates a remote device 110 that has a connection management module 112, according to an embodiment of the present disclosure. The remote device 110 can be, for example, a wireless handheld device such as a mobile phone or a personal digital assistant (PDA), a wireless processing device (e.g., computer), and so forth. The remote device 110 is configured to communicate with a processing device 130 of a server 120 through a wireless gateway 150 of a network 170. The network 170 can be any type of network such as a local area network (LAN) and/or a wide area network (WAN) implemented as a wired network and/or a wireless network (e.g., a cellular/mobile network, a wi-fi network, a wireless LAN) in a variety of environments such as, for example, an office complex or within a city. The network 170 can have one or more segments and can be configured to transmit information. The information can be based on or carried by, for example, a data signal, a control signal, and/or a media signal (e.g., an audio signal, a video signal).

As shown in FIG. 1, the wireless gateway 150 has a coverage area 152 defined by a combination of a wireless communication capability of the wireless gateway 150 and a wireless communication capability of the remote device 110. The coverage area 152 is the area within which the wireless gateway 150 and the remote device 110 can communicate with one another. In other words, if the wireless gateway 150 and/or the remote device 110 are unable to communicate with one another (e.g., unable to successfully send a signal and receive an acknowledgement), the remote device 110 is typically outside of the coverage area 152. The remote device 110 is considered in-coverage when the remote device 110 is within the coverage area 152, and the remote device 110 is considered out-of-coverage when the remote device 110 is outside of the coverage area 152. The coverage area 152 can be referred to as an in-coverage area.

When the remote device 110 moves outside of coverage area 152, the connection management module 112 can be configured to prevent the remote device 110 from wirelessly transmitting one or more signals associated with wireless connectivity such as, for example, a ping packet (e.g., a connection keep-alive request, a socket keep-alive request) or a connection request (e.g., a reconnect request). The signals associated with wireless connectivity can be referred to as wireless connectivity signals.

One or more of these wireless connectivity signals can be suppressed and/or modified to preserve battery life and/or processing resources of the remote device 110. In one or more embodiments, the frequency of wireless connectivity signals can be modified (e.g., reduced). For example, in one or more embodiments, the connection management module 112 can be configured to prevent the remote device 110 from attempting to reconnect with the processing device 130 via the wireless gateway 150 when the remote device 110 is out-of-coverage. In one or more embodiments, the remote device 110 can prevent specified types of wireless connectivity signals, such as a reconnection request, from being transmitted from the remote device 110 until the remote device 110 is once again within the coverage area 152. In one or more embodiments, the remote device 110 can be configured to suppress attempts at reconnection of a voice communication link and/or a data communication link with the server 120 and/or a separate device (not shown) when at least one of these links is prematurely terminated. A communication link can also be referred to as a connection (e.g., a voice communication link can be referred to as a voice connection). In one or more embodiments, the communication link can be associated with a session.

The connection management module 112 can trigger/allow sending of one or more connectivity signals in response to remote device 110 being moved within the coverage area 152. In one or more embodiments, the connection management module 112 can trigger by sending, for example, a keep-alive timing signal to a wireless connectivity signal. A keep-alive timing signal is a signal configured to trigger a keep-alive request. A keep-alive request is a request configured to keep active a connection associated with the remote device 110. The keep-alive request can be defined to prevent termination of, for example, an idle connection associated with the remote device 110. More details related to keep-alive requests and keep-alive timing signals are discussed in connection with FIGS. 2 through 6.

In one or more embodiments, the connection management module 112 can be configured to perform a function based on one or more instructions (e.g., a sequence of instruction, a program, and/or an algorithm) stored at the remote device 110. For example, the instructions can be stored in and accessed from, for example, a memory (not shown) and can be executed at a processor (not shown) associated with the connection management module 112. The functions associated with the connection management module 112 can be included in, for example, one or more software modules and/or hardware modules.

FIG. 2 is a schematic diagram that illustrates a connection management module 280 that has a keep-alive module 210, a connection module 220, a coverage detection module 230, and a control module 240, according to an embodiment of the present disclosure. The connection management module 280 is configured to manage wireless connection activity (e.g., reconnection activity) associated with an application 290 of a remote device 200. Specifically, the connection management module 280 is configured to manage wireless connectivity signals associated with the application 290 based on whether or not the remote device 200 is in-coverage or out-of-coverage. In one or more embodiments, the connection management module 280 can be configured to manage wireless connectivity signals associated with more than one application (not shown). The application 290 can be, for example, a communication application such as a push based e-mail application, an instant messaging application (short message service (SMS) based application), and/or a voice communication application. In one or more embodiments, one or more functions associated with modules 210, 220, 230, and 240 can be combined and/or can be included in a module separate (not shown) from the connection management module 280.

As shown in FIG. 2, the remote device 200 also has a user-interface 270, a wireless input/output component 250, and an operating system 260. The user-interface 270 can be, for example, a display (e.g., a touch screen display, and/or a set of indicators) and/or a component for triggering functions of the remote device 200 (e.g., a button, a keyboard, a mouse, and/or a scroll wheel). The user-interface 270 can be used to display information associated with a portion of the application 290 and/or can be used to interact with the application 290 (e.g., used to trigger a function associated with the application 290).

In one or more embodiments, the user-interface 270 can be used to display a status associated with the connection management module 280. For example, if the connection management module 280 triggers an attempt to connect (or reconnect) with a separate device (not shown), the connection management module 280 can trigger a connection indicator (or reconnection indicator) to be displayed on the user-interface 270.

The wireless input/output component 250 can be, for example, a wireless network input/output device (e.g., a wireless network card) that can include an antenna (not shown). The wireless input/output component 250 can be used to transmit any type of information based on or carried by, for example, a wireless connectivity signal, a data signal, and/or a media signal associated with the application 290. In one or more embodiments, the input/output component 250 is linked with or operatively coupled to, for example, the application 290, the connection management module 280 and/or the user-interface 270 by the operating system 160.

The coverage detection module 230 is configured to determine whether or not the remote device 200 is in-coverage or out-of-coverage. The coverage detection module 230 can be configured to determine whether or not the remote device 200 is in-coverage based on an in-coverage indicator from the operating system 260. For example, the coverage detection module 230 can be configured to register with the operating system 260 so that the coverage detection module 230 will receive in-coverage indicators and/or out-of-coverage indicators when they are generated by a portion of the operating system 260. In one or more embodiments, when some mobile operation systems are employed, such as Palm and Windows mobile, the coverage detection module 230 will receive a coverage indicator that includes a value of the signal strength as well as a minimum value of the signal strength over which data transmission is possible. In order for the transmission of data to be reliable, it is necessary for the a certain threshold value of signal strength to be met.

The keep-alive module 210 can be configured to trigger one or more keep-alive requests defined to request that a connection and/or a socket associated with the application 290 be maintained (e.g., not terminated) for a specified period of time. The keep-alive request can be defined to prevent termination of, for example, an idle connection associated with the application 290. For example, the keep-alive module 210 can send a keep-alive request to the operating system 260 so that the operating system 260 will maintain a connection associated with the application 290 or maintain an assignment of a socket to the application 290. In other words, the keep-alive request can be configured to suspend termination of the connection and/or the socket. The keep-alive module 210 can be configured to send a keep-alive request to the operating system 260 even when the application 290 is not actively using the connection and/or the socket. The connection can be, for example, a two-way communication associated with a session between the remote device 200 and a separate device (not shown).

In one or more embodiments, the keep-alive module 210 can be configured to send a keep-alive request to a server (not shown in FIG. 2) managing a connection between the application 290 of the remote device 200 and a separate device (not shown in FIG. 2) so that the server will, at least temporarily, suspend termination of the connection. For example, the keep-alive module 210 can send a keep-alive request to the server so that the server will not, at least for a specified period of time, re-assign the socket for use with a different connection. In one or more embodiments, the keep-alive request is used to prevent the wireless gateway from garbage collecting the socket connection.

The keep-alive module 210 can be configured to send a keep-alive request in response to a keep-alive timing signal from a keep-alive timer 212. The keep-alive timer 212 can be configured to trigger a keep-alive request, for example, periodically based on a specified time interval that can be referred to as a keep-alive time interval. For example, the keep-alive timer 212 can be configured to attempt to trigger a keep-alive request every two minutes. Said differently, the keep-alive timer 212 can be configured to trigger (e.g., define) a keep-alive timing signal every two minutes that can trigger sending of a keep-alive request. The keep-alive timing signal can be transmitted between modules internal to the remote device 200 while the keep-alive request can be transmitted from the remote device 200 to device(s) and/or server(s) external to the remote device 200.

In one or more embodiments, a keep-alive time interval can have a duration defined based on a specification associated with a known server of a network (not shown in FIG. 2) or a known set of servers associated with the network (e.g., a set of servers associated with a cell-phone service provider). For example, a server (or set of servers) can be configured to terminate idle connections based on a specified time interval. The specified time interval can be referred to as a connection collection interval. The keep-alive timer 212 can have a keep-alive time interval defined based on the connection collection interval so that the remote device 200 can strategically send keep-alive requests to prevent collection of idle connections associated with, for example, application 290. In one or more embodiments, the keep-alive time interval of the keep-alive timer 212 can be reset when a desirable response to a keep-alive request is received.

The connection module 220 is configured to send one or more connection requests to establish a connection with, for example, a separate device (not shown in FIG. 2) via a server (not shown in FIG. 2). The connection module 220 can be configured to send a request to reconnect with the separate device if a connection between the separate device and the remote device 200 has been prematurely terminated. In one or more embodiments, the connection request can be, for example, a session initiation signal defined based on a session initiation protocol. In one or more embodiments, the keep-alive time interval of the keep-alive timer 212 can be reset when a desirable response to a connection request is received.

The control module 240 is configured to trigger and/or suppress one or more functions of the keep-alive module 210, the connection module 220, and/or the coverage detection module 230. For example, the control module 240 can prevent the connection module 220 from sending a connection request in response to an indicator from the coverage detection module 230 that the remote device 200 is out-of-coverage. In one or more embodiments, the control module 240 can prevent the keep-alive module 210 from sending a connection request in response to an indicator from the coverage detection module 230 when the remote device 200 is out-of-coverage.

In one or more embodiments, the control module 240 can trigger the coverage detection module 230 to actively query the operating system 260 to determine whether or not the remote device 200 is in-coverage. Querying can include sending one or more request/signals from the connection management module 280 and/or receiving one or more responses/signals from the operating system 260 of the remote device 200. In one or more embodiments, the coverage detection module 230 can be configured to (e.g., can be triggered by control module 240 to) actively query the operating system 260 to determine whether or not the remote device 200 is in-coverage in response to the keep-alive timing signal from the keep-alive timer 212.

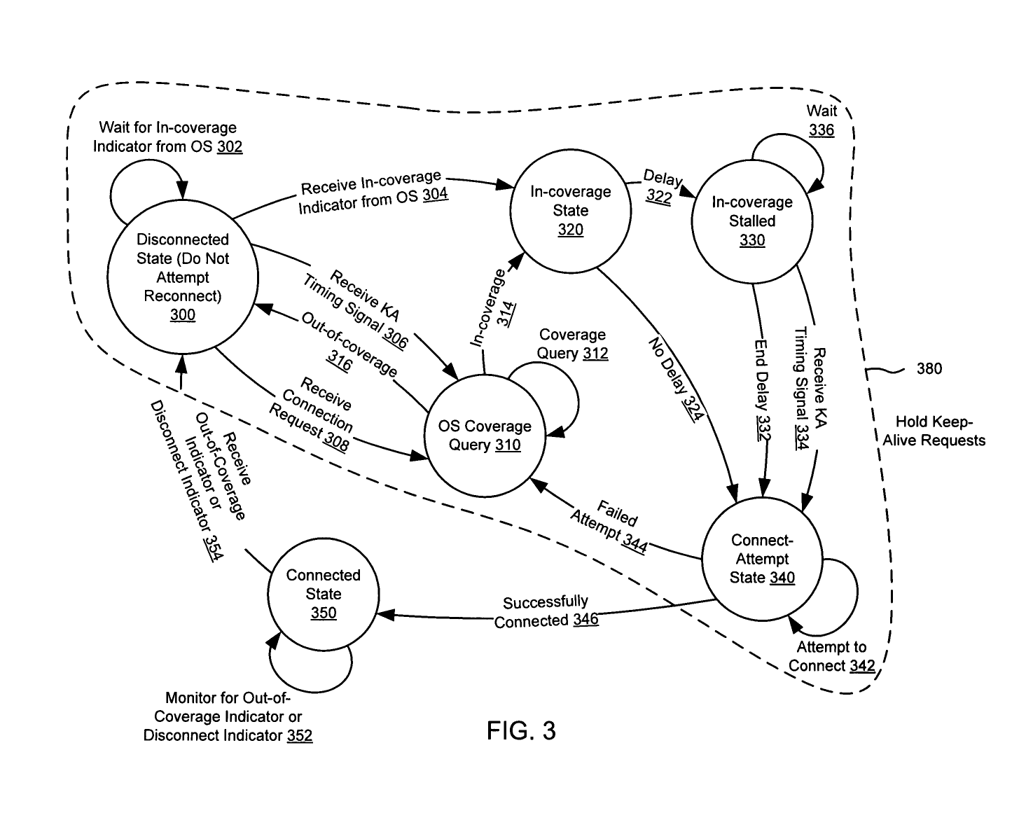

FIG. 3 is a schematic diagram that illustrates a connection management procedure that can be implemented by a connection management module of a remote device, according to an embodiment of the present disclosure. The connection management module can be similar to the connection management module 280 shown in FIG. 2 and can be associated with a specific communication application (e.g., application 290) or a communication application module. As shown in FIG. 3, the connection management procedure illustrates several states, triggering signals, and functions associated with the connection management module. In one or more embodiments, the connection management procedure can be referred to as a reconnection management procedure if the connection management procedure is being executed in response to a connection being disconnected.

In this embodiment, keep-alive requests are suppressed (e.g., not sent) from the remote device when the connection management module is in any of the states in region 380. The states in region 380 can be referred to collectively as disconnected states. In one or more embodiments, transmission of the keep-alive requests from the remote device can be prevented (e.g., suppressed, put on hold), even if the keep-alive requests may have been defined. Sending of the keep-alive requests is prevented by the connection management module to, for example, preserve battery life and/or processing resources of the remote device. In one or more embodiments, sending of keep-alive requests is only allowed when in a connected state 350 or a sub-state (not shown) associated with the connected state 350. Although keep-alive requests are suppressed in the states of region 380, in this embodiment, keep-alive timing signals are not suppressed. The keep-alive timing signals are used to trigger connection requests (or reconnection requests).

As shown in FIG. 3, when in a disconnected state 300, the connection management module does not attempt to connect (or trigger an attempt to connect) and waits for an in-coverage indicator 302 from, for example, an operating system of the remote device. The remote device can be in the disconnected state 300 when the remote device is outside of a coverage area. In one or more embodiments, the remote device can be in the disconnected state 300 when a user intentionally or unintentionally terminates a connection. In one or more embodiments, the connection management module of the remote device can be configured to actively monitor for an in-coverage indicator.

In one or more embodiments, while in the disconnected state 300, the connection management module can trigger a notification at a user-interface that the remote device is currently disconnected. The notification can be, for example, an audible notification (e.g., a ping sound) and/or a text-based notification (e.g., a “disconnected” message) that indicates that the remote device is currently disconnected from at least one device.

If an in-coverage indicator is received 304 from, for example, an operating system of the remote device while the connection management module is in the disconnected state 300, the connection management module can change from the disconnected state 300 to an in-coverage state 320. The connection management module of the remote device can be in the in-coverage state 320 when the remote device is located within a coverage area. Although the connection management module of the remote device is in the in-coverage state 320, the connection management module has not yet triggered establishment of connection with a separate device, and is thus, not in a connected state 350.

In one or more embodiments, while in the in-coverage state 320, the connection management module can trigger a notification at a user-interface that the remote device is currently in-coverage. The notification can be, for example, an audible notification (e.g., a ping sound) and/or a text-based notification (e.g., an “in-coverage” message) that indicates that the remote device is currently in at least one coverage area.

The connection management module of the remote device changes to a connect-attempt state 340 from the in-coverage state 320 when the remote device is able to respond immediately to the in-coverage indicator 304. The connection management module can respond immediately when the in-coverage indicator 304 is not delayed 324 by, for example, a processing error and/or insufficient processing resources. While in the connect-attempt state 340, the connection management module is configured to attempt (or trigger an attempt) to connect 342 with a server and/or a separate device. The connection management module of the remote device can be configured to attempt to connect 342 by sending one or more session initiation signals to the server and/or the separate device. The session initiation signals can be sent from a connection module of a connection management module. In one or more embodiments, the connection management module of the remote device can be configured to attempt to connect 342 a specified number of times.

In one or more embodiments, while in the connect-attempt state 340, the connection management module can be configured to trigger a notification at a user-interface that the remote device is currently attempting to connect to another device (e.g., a separate remote device, a separate server). The notification can be, for example, an audible notification and/or a text-based notification (e.g., an “attempting to connect” message).

The connection management module of the remote device can change from the in-coverage state 320 to an in-coverage stalled state 330 when a delay 322 prevents the connection management module from immediately responding to the in-coverage indicator that triggered the change to the in-coverage state 320. A delay 322 can be caused by, for example, a corrupt (e.g., improper) in-coverage indicator, insufficient processing resources, and/or a processing error that prevents the in-coverage indicator from being received at the connection management module.

While in the in-coverage stalled state 330, the connection management module can wait 336 until the delay is ended 332 or wait 336 until it receives a keep-alive timing signal 334. When at least one of these events occurs, the connection management module can change from the in-coverage stalled state 330 to the connect-attempt state 340. The delay can end 332, for example, when a processing error related to the in-coverage indicator is corrected or when another in-coverage indicator 314 is received. The keep-alive timing signal 334 can be received from a keep-alive timer based on a keep-alive interval.

If an attempt (or specified set of attempts) to connect fails 344 while in the connect-attempt state 340 because, for example, a network is unavailable or a separate device (e.g., server, destination device) denies a request for a connection, the connection management module of the remote device can change to an operating system (OS) coverage query state at 310. While in the OS coverage query state 310, the connection management module can be configured to perform a coverage query 312. In one or more embodiments, the connection management module can actively query, for example, an operating system of the remote device to determine whether or not the remote device is within a coverage area. In one or more embodiments, the connection management module can trigger a notification at a user-interface that the remote device is currently determining whether or not the remote device is within a coverage area via, for example, an audible notification and/or a text-based notification (e.g., an “determining coverage” message).

The connection management module can return to the in-coverage state 320 if it is determined that the remote device is in-coverage 314 based on the coverage query 312 while the connection management module is in the OS coverage query state 310. The connection management module can return to the disconnected state 300 if it is determined that the remote device is out-of-coverage 316 based on the coverage query 312.

When the remote device successfully connects 346 (e.g., reconnects) with another device (e.g., a separate remote device, a server), the connection management module of the remote device can change from the connect-attempt state 340 to a connected state 350. While in the connected state 350, the connection management module of the remote device can be configured to monitor for an out-of-coverage indicator and/or a disconnect indicator 352. The out-of-coverage indicator is an indicator that the remote device is no longer in-coverage. The disconnect indicator is an indicator that a connection with an application of the remote device has been terminated. In one or more embodiments, the disconnect indicator can be triggered by a user of the remote device.

The connection management module can change to the disconnected state 300 from the connected state 350 when an out-of-coverage indicator and/or a disconnect indicator 354 is received. In one or more embodiments, the connection management module can be configured to trigger sending of a ping packet in response to an out-of-coverage indicator 354 to determine whether or not the remote device is outside of a coverage area.

In one or more embodiments, the connection management module can trigger a notification at a user-interface that the remote device is currently connected while in the connected state 350. The notification can be, for example, an audible notification (e.g., a ping sound) and/or a text-based notification (e.g., a “connected” message) that indicates that the remote device is currently connected with at least one device.

The connection management module can also change from the disconnected state 300 to the OS coverage query state 310 in response to a connection request 308. The connection request 308 can be a connection request triggered by a user or by an application associated with the connection management module.

The connection management module of the remote device can also change from the disconnected state 300 to the OS coverage query state 310 when a keep-alive timing signal 306 is received. The keep-alive timing signal can be received from a keep-alive timer associated with the connection management module.

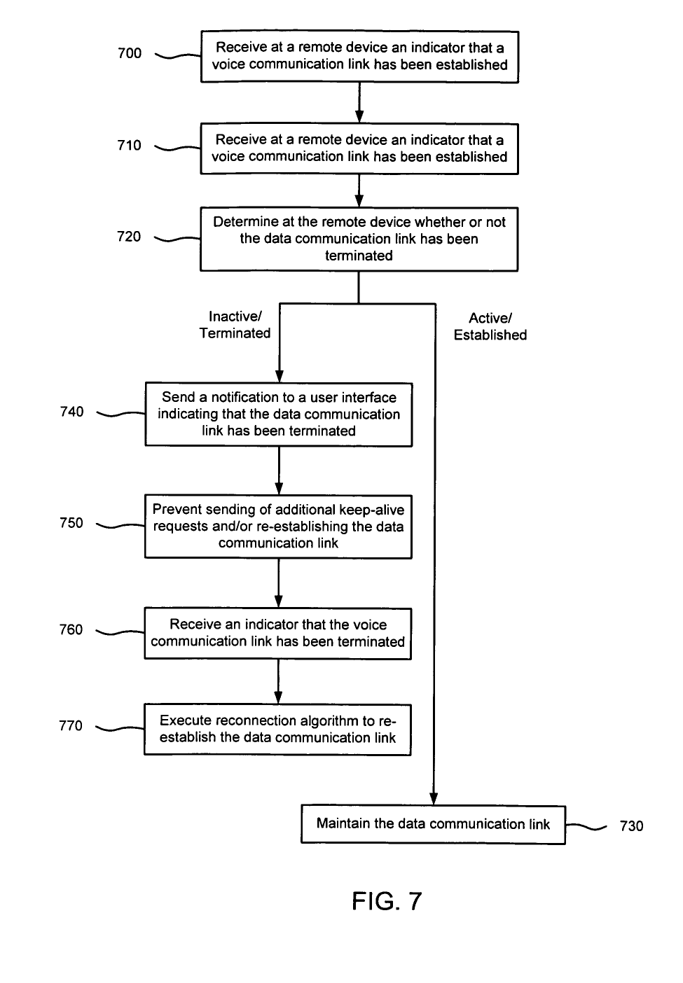

In one or more embodiments, the connection management procedure can be a procedure associated with a data communication link and/or a voice communication link. In other words, the connection management procedure shown in FIG. 3 can be implemented on a remote device with both voice communication capabilities and/or data communication capabilities. More details related to a connection management module of a remote device configured to manage both voice communication and data communications links is described in connection with FIG. 7.

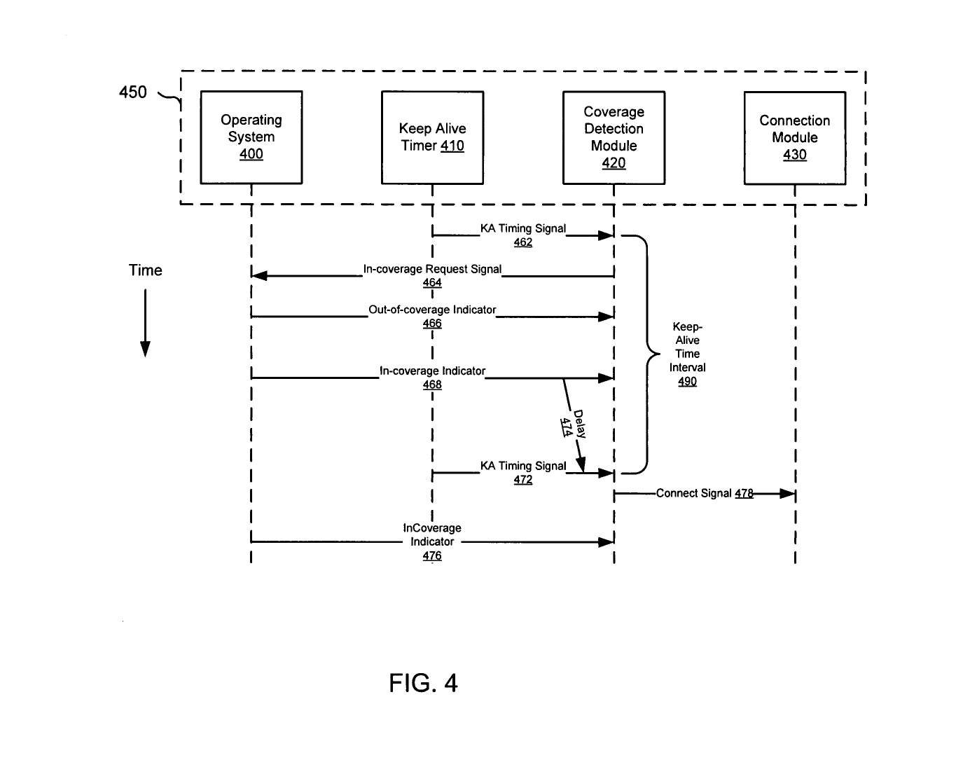

FIG. 4 is a timing diagram that illustrates a signal exchange scenario based on the connection management procedure illustrated in FIG. 3, according to an embodiment of the present disclosure. Specifically, the timing diagram illustrates signals transmitted between an operating system 400, a keep-alive timer 410, a coverage detection module 420, and a connection module 430. Each of these components is associated with a remote device 450.

As shown in FIG. 4, a keep-alive timing signal 462 is sent from the keep-alive timer 410 to the coverage detection module 420. In response to the keep-alive timing signal 462, the coverage detection module 420 sends an in-coverage request signal 464 to the operating system 400 to determine whether or not the remote device 450 is in-coverage. In response to the in-coverage request signal 464, the operating system 400 defines and sends an out-of-coverage indicator 466 to the coverage detection module 420 indicating that the remote device 450 is not in-coverage.

After a period of time, the operating system 400 sends an in-coverage indicator 468 to the coverage detection module 420. As shown in FIG. 4, a delay 474 prevents the coverage detection module 420 from immediately acting on the in-coverage indicator 468. During the delay 474, a keep-alive timing signal 472 is received and the coverage detection module 420 sends a connection signal before in-coverage indicator 476 is received at the coverage detection module 420. In response to the keep-alive timing signal 472, the coverage detection module 420 can send a connect signal 478 to trigger the connection module 430 to request a connection with a separate device (e.g., a server, a separate remote device). Because the coverage detection module 420 is configured to send a connect signal 478 in response to the keep-alive timing signal 472, the delay 474 will only be temporary and the remote device 450 can attempt to connect (or reconnect) before in-coverage indicator 476 is sent.

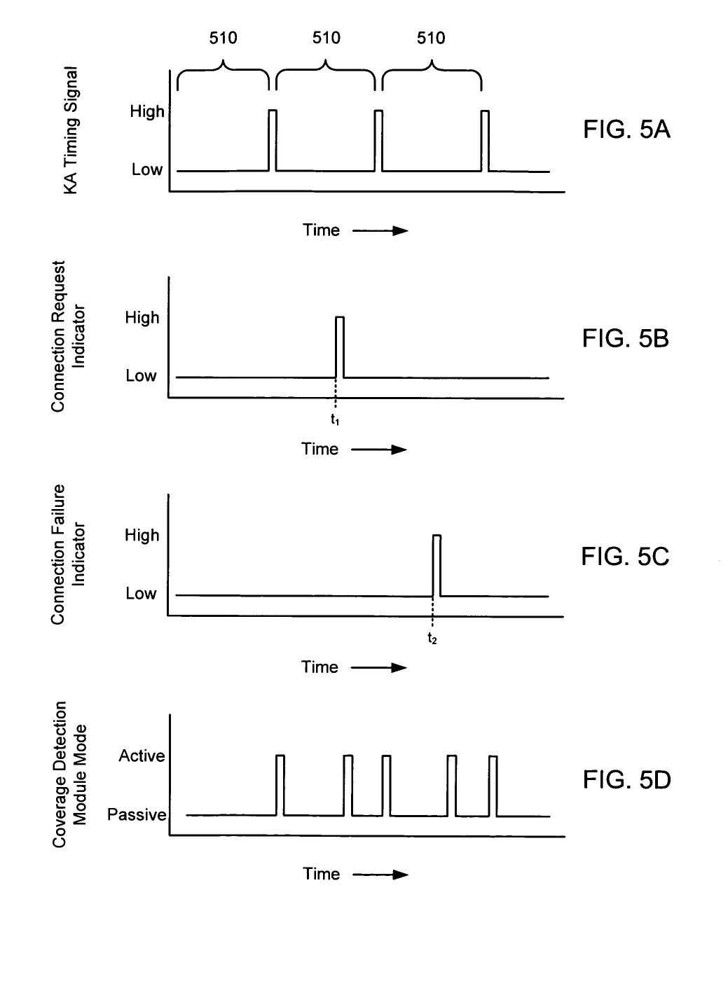

FIGS. 5A, 5B, and 5C are graphs that illustrate several signals associated with an implementation of the connection management procedure illustrated in FIG. 3, according to an embodiment of the present disclosure. Specifically, FIG. 5A is a graph that illustrates a keep-alive timing signal from a keep-alive timer, according to an embodiment of the present disclosure. FIG. 5B is a graph that illustrates a connection request indicator, according to an embodiment of the present disclosure. FIG. 5C is a graph that illustrates a connection failure indicator, according to an embodiment of the present disclosure. FIG. 5D is a graph that illustrates a mode of a coverage detection module based on the keep-alive timing signal shown in FIG. 5A, the connection request indicator shown in FIG. 5B, and the connection failure indicator shown in FIG. 5C, according to an embodiment of the present disclosure.

As shown in FIG. 5A, the keep-alive timing signal is high for a short period of time between the keep-alive time intervals 510. A keep-alive request can be triggered when the keep-alive timing signal is high. As shown in FIG. 5B, a connection request that has been defined is sent at time t₁. As shown in FIG. 5C, a connection failure indicator is high at time t₂. FIG. 5D illustrates that a mode of a coverage detection module changes from an passive mode to an active mode in response to the keep-alive timing signal (shown in FIG. 5A), in response to the connection request indicator (shown in FIG. 5B), and in response to the connection failure indicator (shown in FIG. 5C). When in the active mode, a coverage detection module can be configured to actively query an OS to determine whether or not a remote device is in-coverage.

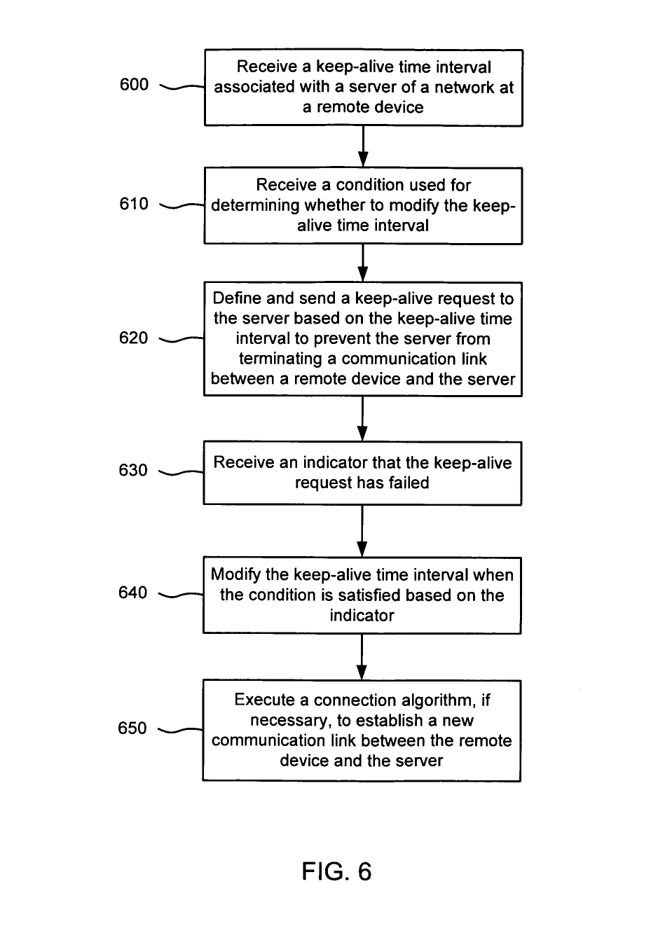

FIG. 6 is a flowchart that illustrates a method for dynamically modifying a keep-alive time interval at a remote device, according to an embodiment of the present disclosure. In one or more embodiments, the remote device can be a wireless handheld device. The keep-alive time interval can be dynamically modified when the remote device has a keep-alive time interval based on a known connection collection interval associated with a server and establishes a connection via a server with an unknown connection collection interval. In one or more embodiments, the keep-alive time interval can be modified with the use of at least one algorithm when a connection collection interval of a server changes (e.g., unexpectedly changes, or the wireless device connects to a different wireless gateway and/or server having a different connection collection interval).

As shown in the flowchart, a keep-alive time interval associated with a first server of a network is received at a remote device at 600. The keep-alive time interval can be defined at the remote device based on a specification associated with the server. In one or more embodiments, the server can be associated with a group of servers of a network.

A condition used to determine whether to modify the keep-alive time interval is received at 610. In one or more embodiments, the condition for modifying the keep-alive time interval can be defined at the remote device and/or can be received at the remote device from a system administrator associated with the remote device. In one or more embodiments, the condition can be part of a keep-alive time interval modification procedure and can be included in an instruction. The condition can include one or more threshold values and/or logic (e.g., Boolean logic) that can be used to trigger one or more events. For example, a remote device can be configured to modify a keep-alive time interval by a specified percentage (e.g., increase by a specified percentage) when three consecutive keep-alive requests fail.

A keep-alive request is defined and sent to a server based on the keep-alive time interval to prevent the server from terminating a communication link between a remote device and the server at 620. In response to the keep-alive request, an indicator that the keep-alive request has failed is received at 630. The keep-alive time interval is modified when the condition is satisfied based on the indicator at 640. The keep-alive time interval can be modified based on the condition.

A connection algorithm (or reconnection algorithm) can be executed, if necessary, to establish (or re-establish) a communication link between the remote device and the server at 650. The connection algorithm can be based on the connection management procedure shown in FIG. 3.

FIG. 7 is a flowchart that illustrates a method for managing a connection of a data communication link when a voice communication link associated with a remote device is active, according to an embodiment of the present disclosure. Specifically the method shown in FIG. 7 is configured to prevent reconnection of a data communication link if the data communication link is terminated (e.g., dropped) while a voice communication link is active. In one or more embodiments, the data communication link and the voice communication link can be based on different communication protocols.

The remote device can be configured to communicate via, for example, a third generation (3G) remote device network (e.g., a Wideband Code Division Multiple Access (W-CDMA) network, a High-Speed Packet Access (HSPA) network) that allows for a simultaneous data communication link(s) and voice communication link(s). A connection management module, such as that shown in FIG. 1, can be configured to manage reconnections of the data communication link and/or the voice communication link according to the method shown in FIG. 7.

As shown in FIG. 7, an indicator that a voice communication link has been established is received at a remote device at 700. In one or more embodiments, the indicator can be associated with an on-hook event. An indicator that a data communication link has been established is received at the remote device at 710. The voice communication link can be established using a voice communication application installed on the remote device, and the data communication link can be established using a data communication application installed on the remote device.

At 720, the remote device determines whether or not the data communication link has been terminated. The determination can be made at a connection management module based on an indicator from an operating system of the remote device. In one or more embodiments, the connection management module can be configured to send a ping packet to a network to determine whether or not the data communication link is still active.

If the data communication link is active (e.g., still established), the data communication link is maintained at 730. The data communication link can be maintained using, for example, keep-alive requests sent to a server and/or sent from a connection management module to an operating system of the remote device.

If the data communication link is no longer active (e.g., has been terminated), a notification is sent to a user interface indicating that the data communication link has been terminated at 740. The notification can be, for example, an audible notification (e.g., a ping sound) and/or a text-based notification (e.g., a “disconnected” message) indicating that the data communication link has been terminated.

Sending of additional keep-alive requests and/or re-establishing the data communication link is prevented at 750. After an indicator that the voice communication link has been terminated is received at 760, a reconnection algorithm to re-establish the data communication link can be executed at 770. In one or more embodiments, the indicator of the voice communication link being terminated can be associated with an off-hook event. The reconnection algorithm can be based on at least a portion of the connection management procedure shown in FIG. 3.

One or more embodiments relate to a computer storage product with a computer-readable medium (also can be referred to as a processor-readable medium) having instructions or computer code thereon for performing various computer-implemented operations. The media and computer code (also can be referred to as code) may be those specially designed and constructed for the specific purpose or purposes. Examples of computer-readable media include but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as floppy optical disks; carrier wave signals; and hardware devices that are specially configured to store and execute program code, such as application-specific integrated circuits (ASICs), Programmable Logic Devices (PLDs), and read-only memory (ROM) and random-access memory (RAM) devices. Examples of computer code include, but are not limited to, micro-code or micro-instructions, machine instructions, such as produced by a compiler, and files containing higher-level instructions that are executed by a computer using an interpreter. For example, an embodiment of the present disclosure may be implemented using Java, C++, or other object-oriented programming language and development tools. Additional examples of computer code include, but are not limited to, control signals, encrypted code, and compressed code.

In conclusion, among other things, methods and apparatus related to connection handling (e.g., reconnection handling) associated with a wireless device are described. While various embodiments have been described above, it should be understood that they have been presented by way of example only, and various changes in form and details may be made. For example, multiple connection management procedures can be configured operate in concert at a remote device.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

In addition, although certain illustrative embodiments and methods have been disclosed herein, it can be apparent from the foregoing disclosure to those skilled in the art that variations and modifications of such embodiments and methods can be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

1. A method, comprising:
sending a keep-alive request from a wireless device to a server based on a first keep-alive time interval;
receiving at least one indicator that the keep-alive request has failed; and
defining a second keep-alive time interval different from the first keep-alive time interval in response to at least one condition being satisfied and in response to the receiving.

2. The method of claim 1, wherein the defining includes defining the second keep-alive time interval when a response to the keep-alive request is not received from the server within a threshold time period associated with the at least one condition.

3. The method of claim 1, wherein the server is associated with a first wireless network, the method further comprising:
defining the first keep-alive time interval before the sending based on a preference associated with a server associated with a second wireless network different than the first wireless network.

4. The method of claim 1, wherein the keep-alive request is a first keep-alive request, the at least one indicator is an indicator that a first communication link has been terminated by the server,
the method further comprising:
establishing a second communication link between the wireless device and the server based on at least one reconnection algorithm; and
sending a second keep-alive request to the server based on the second keep-alive time interval.

5. The method of claim 1, wherein the keep-alive request is a first keep-alive request, the sending including sending the first keep-alive request over a first communication link,
the method further comprising:
querying an operating system of the wireless device after the receiving to determine whether the wireless device is in an in-coverage state;
establishing a second communication link between the wireless device and the server in response to the wireless device being in the in-coverage state; and
sending a second keep-alive request to the server based on the second keep-alive time interval.

6. A processor-readable medium storing code representing instructions to cause a processor to perform a process, the code comprising code to:
query an operating system of a wireless device to determine whether the wireless device is in an in-coverage state in response to a timing signal produced by a keep-alive timer, the timing signal configured to trigger a keep-alive request;
receive at least one indicator that the wireless device is in the in-coverage state in response to the query; and
send a request to establish a communication link between the wireless device and a server in response to the at least one indicator.

7. The processor-readable medium of claim 6, the code further comprising code to:
produce a keep-alive request in response to the timing signal and in response to the at least one indicator that the wireless device is in the in-coverage state.

8. The processor-readable medium of claim 6, wherein the communication link is a first communication link, the code to query includes code to query in response to at least one indicator that a second communication link between the wireless device and the server has been terminated.

9. The processor-readable medium of claim 6, wherein the code to query includes code to query after at least one in-coverage indicator produced by the operating system of the wireless device has failed to trigger a reconnection attempt.

10. The processor-readable medium of claim 6, wherein the timing signal is produced based on a dynamically modified keep-alive time interval.

11. The processor-readable medium of claim 6, wherein the code to query includes code to query when the wireless device is in a disconnected state.

12. A method, comprising:
receiving at a wireless device at least one indicator that a first communication link between the wireless device and a server has been established, the first communication link being based on a first communication protocol;
receiving at least one indicator that a second communication link between the wireless device and the server has been terminated, the second communication link being based on a second communication protocol; and
preventing the wireless device from re-establishing the second communication link in response to the at least one indicator that the second communication link has been terminated.

13. The method of claim 12, wherein the at least one indicator that the second communication link has been terminated is based on a status of a server socket associated with the second communication link.

14. The method of claim 12, wherein the preventing includes preventing until the first communication link has been terminated.

15. The method of claim 12, wherein the first communication link is a voice communication link, the second communication link is a data communication link.

16. The method of claim 12, further comprising:
preventing the wireless device from sending a keep-alive request associated with the second communication link to the server in response to the at least one indicator that the second communication link has been terminated.

17. The method of claim 12, further comprising:
sending a notification that the second communication link has been terminated to a user-interface of the wireless device.

18. The method of claim 12, wherein the preventing includes preventing execution of at least one reconnection algorithm.

19. The method of claim 12, wherein the server is associated with a network that supports simultaneous voice communication links and data communication links.
